(19) United States
(12) Patent Application Publication
(10) Pub. No.: US 2010/0047662 A1
(43) Pub. Date: Feb. 25, 2010

(54) Catalyst Layers Having Thin Film Mesh Catalyst (TFMC) Supported on a Mesh Substrate and Methods of Making the Same

(75) Inventors: Alireza Pezhman Shirvanian, Ann Arbor, MI (US); Shinichi Hirano, West Bloomfield, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/495,839

(22) Filed: Jul. 1, 2009

Related U.S. Application Data
(60) Provisional application No. 61/091,070, filed on Aug. 22, 2008.

(51) Int. Cl. H01M 2/00

(52) U.S. Cl. 429/34

(57) ABSTRACT

According to at least one aspect of the present invention, a fuel cell catalyst layer is provided. In at least one embodiment, the fuel cell catalyst layer includes an interconnected network of first spaced apart strands extending longitudinally in a first direction and second spaced apart strands extending longitudinally in a second direction, the interconnected network defining a number of openings bonded by an adjacent pair of the first spaced apart strands and an adjacent pair of the second space apart strands, and the number of openings forming a passage way; and a metallic catalyst in overlaying contact with at least a portion of the first and second spaced apart strands in the interconnected network.

### CROSS-REFERENCE TO RELATED APPLICATION

This application claims the benefit of U.S. provisional application Ser. No. 60/091,070 filed Aug. 22, 2008.

### BACKGROUND

1. Technical Field

One or more embodiments of this invention relate to catalyst layers having thin film mesh catalyst (TFMC) supported on a mesh substrate and methods of making the same.

2. Background Art

While reliability and working lifetime are routinely considered for utilizing fuel cell (FC) technologies in automotive applications, catalyst activity remains one factor that needs thorough consideration for the ultimate commercialization of fuel cell vehicles. Development of an active and durable catalyst for proton exchange membrane fuel cell (PEMFC) applications may be a challenge. Here, a design to develop an active catalyst while circumventing the degradation and activity problems associated with conventional platinum nano-particles on carbon (Pt/C) based catalyst layers, by, for example, eliminating the catalyst layer and using a metallic thin film on a nano-patterned substrate is described.

### SUMMARY

According to at least one aspect of the present invention, a fuel cell catalyst layer is provided. In at least one embodiment, the fuel cell catalyst layer includes an interconnected network of first spaced apart strands extending longitudinally in a first direction and second spaced apart strands extending longitudinally in a second direction, the interconnected network defining a number of openings bonded by an adjacent pair of the first spaced apart strands and an adjacent pair of the second space apart strands, and the number of openings forming a passage way; and a metallic catalyst in overlaying contact with at least a portion of the first and second spaced apart strands in the interconnected network.

In at least another embodiment, the metallic catalyst includes catalyst atoms aligned along at least one of the first and second spaced apart strands. In certain particular instances, the catalyst atoms are in electric communication with each other.

In at least yet another embodiment, the first and second spaced apart strands are formed of metallic materials, natural polymer materials, synthetic polymer materials, ceramic materials, textile materials, or combinations thereof.

In at least yet another embodiment, the passage way is configured to pass fuel cell reactants including hydrogen molecules, oxygen molecules, water molecules, and combinations thereof.

In at least yet another embodiment, the metallic catalyst includes single crystalline structures, polycrystalline structures, core-shell structures, or combinations thereof. In certain particular embodiments, the metallic catalyst includes platinum and is provided with at least one platinum (111) facet.

In at least yet another embodiment, the interconnected network supports a loading of the metallic catalyst in a range of 0.001 to 0.5 and preferably 0.01 to 0.09 milligrams per square centimeter of total planar surface area of the interconnected network.

In at least yet another embodiment, the interconnected network is provided with a porosity of from 5 to 95 and preferably 25 to 75 percent of total planar surface area of the interconnected network.

In at least yet another embodiment, the metallic catalyst is provided with 1 to 4000 and preferably 1-20 atomic layers. In certain particular instances, the atomic layers form a single crystalline structure.

In at least yet another embodiment, the metallic catalyst includes catalyst metals selected from the group consisting of platinum, gold, silver, palladium, rhodium, iridium, ruthenium, and combinations thereof.

According to at least another aspect of the present invention, a fuel cell electrode assembly is provided. In at least one embodiment, the fuel cell electrode assembly includes a proton exchange membrane and a catalyst layer disposed next to the proton exchange membrane. The catalyst layer includes an interconnected network of first spaced apart strands extending longitudinally in a first direction and second spaced apart strands extending longitudinally in a second direction, the interconnected network defining a number of openings bonded by an adjacent pair of the first spaced apart strands and an adjacent pair of the second space apart strands, and the number of openings forming a passage way for passing fuel cell reactants including hydrogen molecules, oxygen molecules, water molecules, and combinations thereof; and a metallic catalyst in overlaying contact with at least a portion of the first and second spaced apart strands and including catalyst atoms aligned along at least one of the first and second spaced apart strands in the interconnected network.

In at least another embodiment, at least a portion of the openings are filled with an ionomer.

### BRIEF DESCRIPTION OF THE DRAWINGS

FIG. 1A depicts schematic of platinum surface area loss on nano-meter scale in a conventional fuel cell, illustrating (i) platinum particle growth via Oswald ripening, and (ii) precipitation of dissolved platinum forming particles in the ionomer;

FIG. 1B depicts TEM (Transmission Electron Microscopy) image showing the deposition of platinum in the membrane;

FIG. 2A depicts conventional carbon supported platinum nano-particles commonly used in PEMFC catalyst.

Note that all catalyst nano-particles are discrete from each other and do not form a continuum;

FIG. 2B depicts conceptual schematic for TFMC (Thin Film Mesh Catalyst) next to the conventional nano-particles with carbon support for comparison in relation to FIG. 2A;

FIG. 3 depicts PEMFC equipped with a Thin Film Mesh Catalyst (TFMC) supported on a mesh wherein the schematic shows operation of the cathode and similar concept can be adopted for the anode;

FIG. 4 illustratively shows a thin film mesh catalyst (TFMC) with a nickel base and 15 nanometers in thickness platinum deposition along with the GDL;

FIG. 5 depicts ADT (accelerated durability test) for the conventional GDE (5A) and TFMC (5B);

FIGS. 6A-6C depict micro-graphs of the same mesh shown in FIG. 4;

FIG. 6D illustrates spectrum from SEM-assisted elemental analysis showing presence of nickel and platinum;

FIG. 7A depicts TFMC based on a film of pyramid shaped with (111) and (100) surfaces;

FIG. 7B depicts TFMC grown along a diagonal axis to expose maximum numbers of the highly active (111) facets;

FIG. 8A depicts conventional nano-particle catalysts with core-shell structure;

FIG. 8B depicts one embodiment of TFMC with arbitrary mesh covered with platinum or other catalyst thin film wherein catalyst atoms are all bonded to each other to form a continuum;

FIG. 9 depicts a schematic of core-shell catalyst adapted for use in connection with TFMC with the most active facets, (111) facets, exposed on the continuum film;

FIG. 10 demonstrates that the implementation and growth of nano-rods increase reactive surface area while nano-openings provide passage for protons/gas; and

FIG. 11 depicts PEMFC equipped with a thin film mesh catalyst supported on a metallic mesh wherein the schematic shows operation of the cathode with empty openings that allow diffusion of oxygen to reaction sites and similar concept can be applied to the anode.

### DETAILED DESCRIPTION OF EMBODIMENTS OF THE INVENTION

As required, detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in the description and in the claims are to be understood as modified by the word “about” in describing the broader scope of this invention. Practice within the numerical limits stated is generally preferred. Also, unless expressly stated to the contrary, the description of a group or class of material as suitable or preferred for a given purpose in connection with the invention implies that mixtures of any two or more members of the group or class may be equally suitable or preferred.

Fuel cells have been pursued as a source of power for transportation because of their high energy efficiency and their potential for fuel flexibility. Fuel cells have potential for stationary and vehicular power applications; however, commercial viability of fuel cells for power generation in stationary and transportation applications depends upon solving a number of manufacturing, cost, and durability problems.

One problem associated with fuel cell vehicles is the high cost of the fuel cell catalyst. Some of the most efficient catalysts for low temperature fuel cells are noble and transition metals, such as platinum, which are very expensive. Some have estimated that the total cost of such catalysts is approximately 75% of the total cost of manufacturing a low-temperature fuel cell.

As used in conventional systems, an amount of a desired metal catalyst of from about 0.5 to 4 milligrams per square centimeter (0.5-4 mg/cm²) is applied to a fuel cell electrode in the form of an ink, or using complex chemical procedures. Unfortunately, these methods often use a relatively large load of catalyst metals in order to produce a fuel cell electrode with the desired level of electrocatalytic activity, particularly for low temperature applications. Costs associated with the expensive catalyst metals have retarded extensively the broader application of the fuel cell technologies.

A typical fuel cell includes two gas diffusion electrodes (GDEs) sandwiching an electrolyte membrane. Conventional GDEs employ catalyst such as platinum in the form of nano-particles supported on porous carbon support. Due to their inherently high surface energy, nano-particles tend to aggregate to form larger particles, and may actually dissolve into the electrolyte membrane. Issues relating to the use of catalyst in nano-particles, therefore, include loss of surface area due to particle aggregation and loss of catalytic activity due to particle dissolving into the electrolyte membrane. Furthermore, smaller platinum based particles having an electronic structure different from bulk metal, are less reactive than the atoms in the bulk.

Unlike conventional carbon-supported fuel cell catalyst wherein catalyst metals are present in discrete particles and electronic connection between the discrete particles is provided through the carbon support material, the catalyst metal atoms as presented in a continuum film according to one or more embodiments of the present invention are substantially connected to each other electronically without the need for an intermediate connecting medium such as carbon.

Unlike conventional fuel cell catalyst which is either supported on carbon particles embedded in a gas diffusion layer or supported on an electrolyte membrane, the catalyst metals according to one or more embodiments of the present invention are introduced into the fuel cell compartment as a separate layer supported on a mesh substrate.

Efforts have been directed to reduce or avoid the use of nano-particles by, for instance, employing catalysts such as platinum configured as sheets covering the entire active area of the electrolyte membrane. However, several additional issues are associated with these catalyst sheet configurations. First issue is that oxygen/hydrogen gas, water, and protons cannot easily move across the catalyst sheet and as a result, little or no electrochemical reaction happens. Second issue is that even if some oxygen gas, hydrogen gas, and proton do move across the catalyst sheet, resultant water molecules cannot move across the catalyst sheet and therefore often results in water flooding.

For conventional catalyst sheets, only very small atoms, e.g. hydrogen, may be able to cross the thin film catalyst, while product water and larger molecules, e.g., oxygen gas, will be largely blocked. In general, a thin film covering the entire active area of the electrolyte membrane as a continuous sheet does not provide a facile passage for reactants and results in very poor electrochemical activity.

According to one or more embodiments of the present invention, a fuel cell catalyst layer is provided to include an interconnected network of first spaced apart strands extending longitudinally in a first direction and second spaced apart strands extending longitudinally in a second direction, the interconnected network defining a number of openings bonded by an adjacent pair of the first spaced apart strands and an adjacent pair of the second space apart strands, and the number of openings forming a passage way; and a metallic catalyst in overlaying contact with at least a portion of the first and second spaced apart strands in the interconnected network.

As used herein, the term “fuel cell reactants” refer to gases and liquids ordinarily involved in a fuel cell electrochemical reaction. Fuel cell reactants include many species depending upon the fuel cell type. Examples of the hydrogen fuel cell reactants include oxygen gas, hydrogen gas, oxygen ions, hydrogen ions, and water molecules.

In at least one embodiment, the metallic catalyst is configured as a continuum film. As used herein, the term “continuum” refers to a continuous extent, succession, or whole, no part of which can be distinguished from neighboring parts except by arbitrary division.

In at least another embodiment, the continuum film of the metallic catalyst is provided with a continuum dimension greater than 20 nanometers along a longitudinal axis of at least one of the first and second spaced apart strands. As used herein the term “continuum dimension” refers to a dimension of the continuum film in substantially parallel alignment with the facile plane of the fuel cell catalyst layer. By way of example, the continuum dimension can be an x-axis or a y-axis of a planar surface of the fuel cell catalyst layer, as opposed to a thickness axis such as a z-axis that is substantially perpendicular to the planar surface of the fuel cell catalyst layer.

For the purpose of illustration, the fuel cell catalyst accordingly to one or more embodiments of the present invention is generally referred to as “thin film mesh catalyst” or “TFMC”.

One of the benefits of this continuum film with intermittent openings as supported on the mesh substrate is that what stays on the grids of the mesh substrate is not discrete catalyst nano-particles, but a continuum arrangement of catalyst atoms, catalyst crystalline grains, or catalyst in core-shell substructures. One example of the core-shell substructures that can be employed in the TFMC according to one or more embodiments of the present invention is illustratively shown in Zhang et al. (“platinum monolayer on nonnoble metal-metal core-shell nanoparticle electrocatalysts for O reduction;” the Journal of Physical Chemistry B, 2005, 109(48), 22701-22704). Such coating or deposition of the catalyst atoms can be accomplished by sputtering using vapor deposition or atomic layer deposition. Other deposition methods include PVD, CVD, electro-deposition, and colloidal methods. Due to the relatively lower surface energy inherent within the continuum film of catalyst atoms, the resultant catalyst layer is provided with relatively higher stability and activity. Thus, the concept of bulk metal catalyst (“surface composition effects in electrocatalysis: kinetics of oxygen reduction on well-defined PtNi and PtCo alloy surfaces;” Stamenkovi et al., the Journal of Physical Chemistry B; 2002, 106(46), 11970-11979) that is 9-10 times more active relative to catalyst of nano-particles can be effectively employed in the TFMC according to one or more embodiments of the present invention.

The mesh substrate can be made of any suitable materials. Examples of the nano mesh support include ceramics, nickel, steel, copper, iron, cobalt, chromium, and combinations thereof. The mesh could also have surface features to better accommodate catalyst film growth for the desired crystalline structure. The mesh can be porous and or have nano-structures such as nano-wires and nano-rods on it.

The platinum continuum film can be configured to have any suitable thickness for an intended design.

According to one or more embodiments of the present invention, the platinum continuum film can be formed of 1 to 20 and preferably 4 to 10 atomic layers. A total thickness of the platinum continuum film is in a range of 0.5 to 500 nanometers, 2 to 450 nanometers, 10 to 400 nanometers, or 25 to 350 nanometers. In general, the thinner is the mesh, the less is the cross resistance or the ohmic loss, and the better is for energy generation. However, it should be noted that the thickness of the continuum film of the metallic catalyst does not restrict in any way the practice of the present invention. The thickness of the continuum film may be controlled to provide a desirable loading of the metallic catalyst.

The performance of the (100) and (111) crystal surface of bulk catalyst metal such as platinum is far superior to conventional platinum nano-particles. Because the catalyst such as platinum can be grown in single crystals and configured as a thin continuum film on the mesh substrate, this catalyst behaves more like the bulk metal catalyst with preferred crystalline structure and is provided with relatively higher catalytic activity per a given surface relative to the catalyst in conventional nano-particle configuration.

Unlike the atoms contained within the conventional platinum nano-particles, the catalyst atoms contained within the continuum film as supported on the mesh substrate, according to one or more embodiments of the present invention, together form a continuum as they have attained their desirable coordination number and they are not segregated from each other.

It has been found, according to one or more embodiments of the present invention, a platform can be provided for growing single-crystals of catalyst metal alloy such as platinum nickel alloy Pt₃Ni with (111) crystal characteristics to form the continuum catalyst film. This is advantageous because a Pt₃Ni (111) single crystal exhibits up to 90 times better specific activity improvements as compared to the state of the art platinum nano-particles.

According to one or more embodiments of the present invention, the metallic catalyst forming the continuum film can be provided in a core shell configuration. By way of example, a nickel core is covered with a continuous thin shell of platinum atoms. This may be employed in concert with the mesh support to further increase the surface area. Note that surface area may also be increased by adding more mesh grids. The decrease of opening size is not much of a concern. A different mesh with larger openings can resolve the problem, if the catalyst deposit should get very thick.

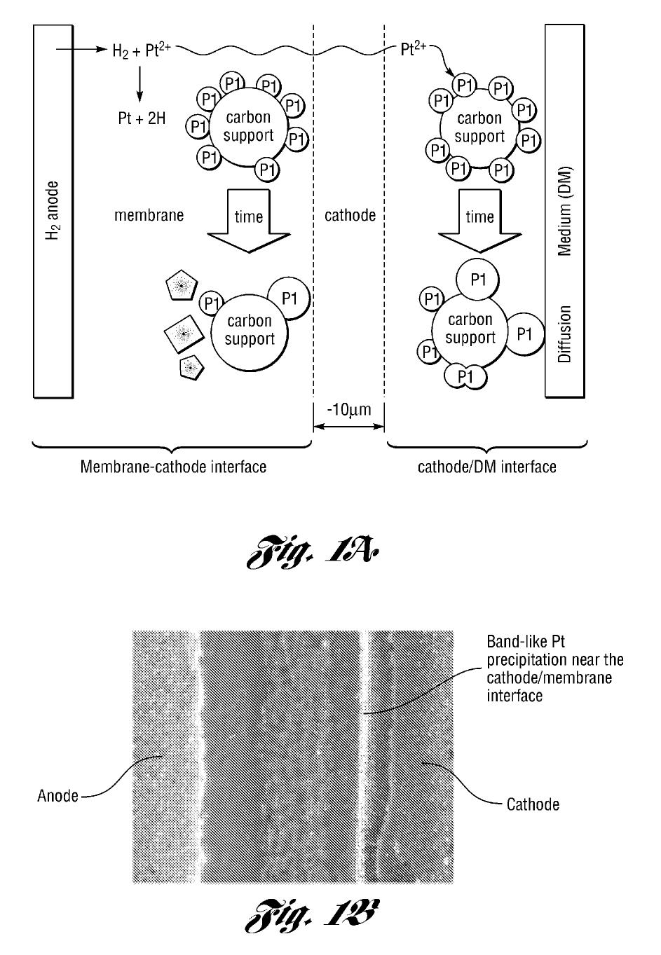

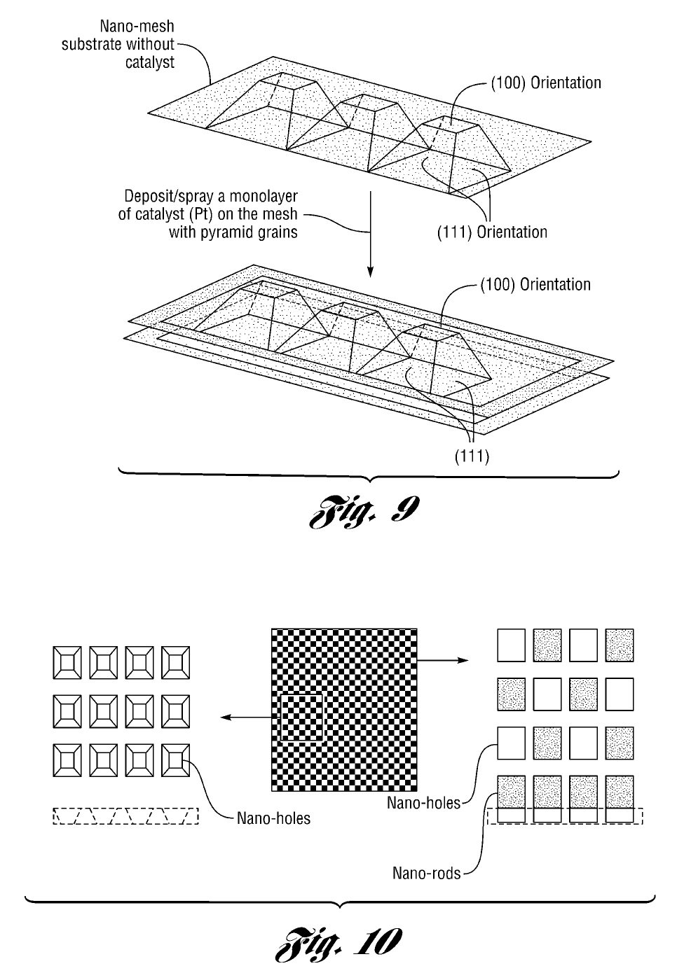

FIG. 8A schematically depicts conventional core-shell nano-particle catalysts wherein a mono-layer of platinum is deposited on the gold nano-particle cores to form the catalysts in PEMPC. Note that the particles are all segregated and do not exhibit bulk or continuum behavior, and therefore are prone to degradation as described herein elsewhere in relative to FIG. 1A.

Considerable efforts have been placed on the electrocatalytic oxygen reduction reaction (ORR) because of its slow kinetics and the need for better electrocatalysts with minimal platinum content for fuel-cell cathodes. Electrocatalysts made with a platinum monolayer supported on metal core nano-particles, configured as what is known as the core-shell nano-particles, show some improvement over conventional platinum based nano-particles, but these electrocatalysts, by virtue of being nano-particles, are still prone to agglomeration, dissolution and other durability issues. One example is illustratively shown in FIG. 1A.

It has been found that the core-shell catalyst nano-particles can be used to form the continuum film that is in overlaying contact with the mesh substrate. When configured in this immediately aforementioned manner, the durability and or the activity of the catalyst are further enhanced.

FIG. 8B illustrates one embodiment of the TFMC supported on mesh. Note that catalyst atoms in this design are contiguous to each other while overlaying the core. The core-shell catalysts of this design are provided with both enhanced activity and durability over conventional core-shell nano-particles.

FIG. 9 shows the core-shell concept as implemented into the TFMC concept according to one or more embodiments of the present invention. FIG. 9 depicts combining the idea of core shell with thin film mesh catalyst (TFMC) while exposing the most active facets, that is (111), on the continuum film of the metallic catalyst. Note that in this design, not only the most active facets of the catalyst, that is the (111) surfaces, is exposed, but also the core-shell technology is implemented wherein the metallic catalyst is in the core-shell configuration.

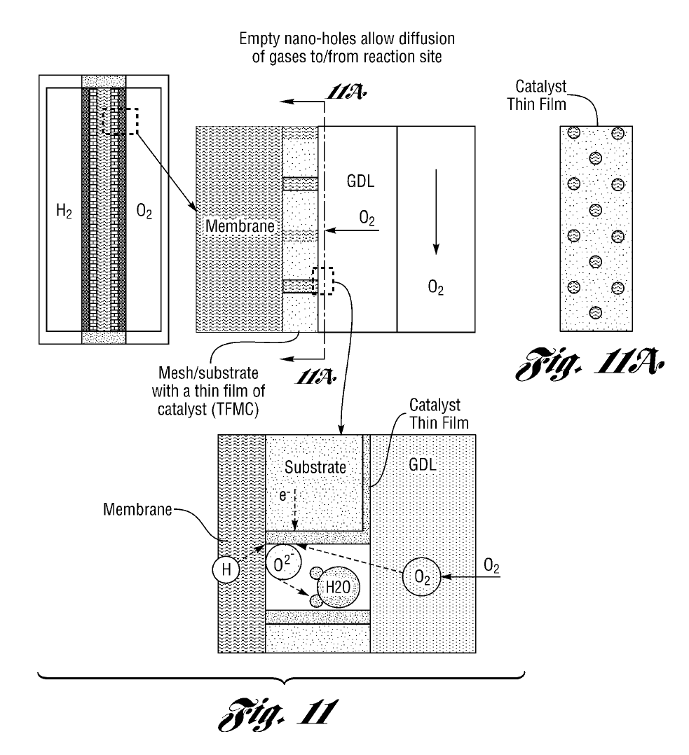

The openings defined by the grids of the mesh substrate, according to one or more embodiments of the present invention, may take any suitable geometric shapes. Examples of the shapes include cones and pyramids such as those depicted in FIG. 10. Moreover, to increase surface area, nano-grids can be implemented in the substrate that may increase the active area substantially. FIG. 10 demonstrates that nano-rods or nano-wires increase reactive surface area while nano-openings provide facile passage for reactants including protons, gases, and water.

According to one or more embodiments of the present invention, the openings may be filled with ionomers to provide additional protonic or ionic connectivity, to assist proton transfer or can be left empty for gases to diffuse down to reach the membrane. When the openings are filled with ionomers, protons can be carried out to the GDL side of the catalyst layer (the mesh layer) where the electrochemical reaction takes place. If the openings are not filled with ionomers, the oxygen gases must instead travel down towards the membrane adjacent to the catalyst layer to meet with proton for reaction.

Whether the nano-openings in the mesh substrate should be filled with ionomers is a matter of design. If nano-openings are filled with ionomer, the protons may be carried out to the catalyst layer adjacent to GDL layer where the electrochemical reaction can happen. This design may be appropriate if the continuum film of the metallic catalyst is relatively thick wherein the presence of ionomers can offset the relatively longer passage protons are to travel from one side of the film to the other. This design may also be more appropriate for low temperature fuel cells where the product water can form droplets that can be removed through GDL. If the openings are not filled with ionomer, the reactive gases must diffuse down the hole to reach the proton rich membrane in order for the reaction to happen.

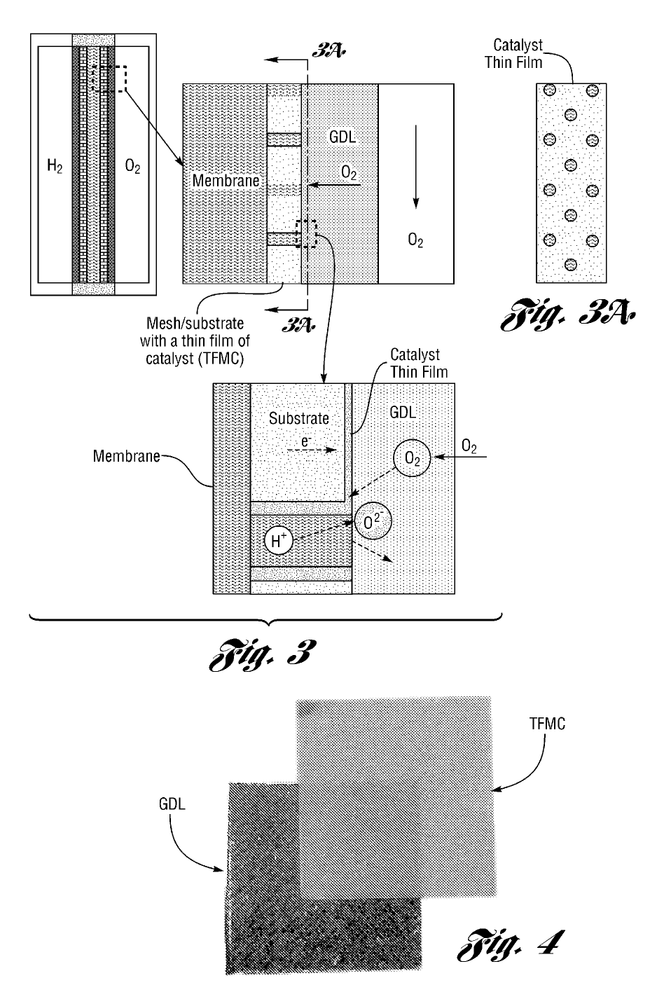

FIG. 3 demonstrates the concept of TFMC on mesh substrates with openings filled with ionomer. FIG. 11 illustrates a configuration when the openings are free of ionomer. When the openings contain no ionomers, fuel cell reactants including reactive gases can diffuse directly through the openings to reach the proton rich membrane.

FIG. 11 depicts PEMFC equipped with a Thin film mesh catalyst (TFMC) supported on a mesh substrate. Schematic shows operation of the cathode with empty nano-holes that allow diffusion of reactants to reaction site. Similar concept can be constructed for the anode. The choice between the concepts in FIG. 3 and FIG. 11 should be made based on careful analysis of the fuel cell operation. Factors to be considered include water management, catalyst film and nano-structure distribution, mesh properties, operating temperatures, etc.

As detailed herein elsewhere, conventional PEMFC catalyst layers based on catalyst nano-particles on carbon support including platinum on carbon and platinum alloy on carbon often suffer from the following degradation mechanisms: 1) platinum dissolution and re-deposition (Oswald ripening process), 2) coalescence of platinum nano-particles via platinum nano-crystallite migration on carbon support, 3) platinum agglomeration triggered by corrosion of carbon support (i.e. detachment of platinum particles from the carbon support), and 4) platinum agglomeration due to high-end operation of fuel cells such as operations under relatively higher temperatures and or voltage cycling due to load variation in driving. Furthermore, unfavorable operating conditions, such as humidity cycling and freeze start for fuel cells can also initiate degradation of the nano-particle catalysts.

All of these mechanisms may result in loss of electrochemically active area and degradation of the performance of PEMFC. FIGS. 1A and 1B illustratively depict these mechanisms schematically. FIG. 1A depicts schematic of platinum surface area loss on nano-meter scale, illustrating (i) platinum particle growth via Oswald ripening, and (ii) precipitation of dissolved platinum forming aggregates in the ionomer. FIG. 1B depicts TEM image showing the deposition of platinum in the membrane. These exemplified mechanisms of catalyst degradation modes have roots in high surface energy associated with particles of smaller size. Nano-particles intrinsically have a high tendency to aggregate and form larger particles to attain a lower and more stable level of energy. A catalyst layer that resembles a single crystal, e.g., (111), bulk metal has relatively higher activity and durability.

According to one or more embodiments of the present invention, the mesh substrate, metallic, non-metallic, or combinations thereof, forms the support upon which the platinum continuum film is in overlaying contact. The mesh substrate can be further designed to provide high catalytic surface area for fuel cell electrochemical reactions, thereby maximizing the triple phase boundaries among the catalyst, the ionomer, and the gases. The mesh substrate support allows facile passage of protons/water and gases through the openings provided therein, while transfer of electrons to and from the reaction site may take place rapidly through the continuous conductive thin film of catalyst or mesh substrate. As will be detailed herein elsewhere, the openings can either be filled with ionomer to assist proton transfer or can be left empty for gases to diffuse down the openings and reach the membrane.

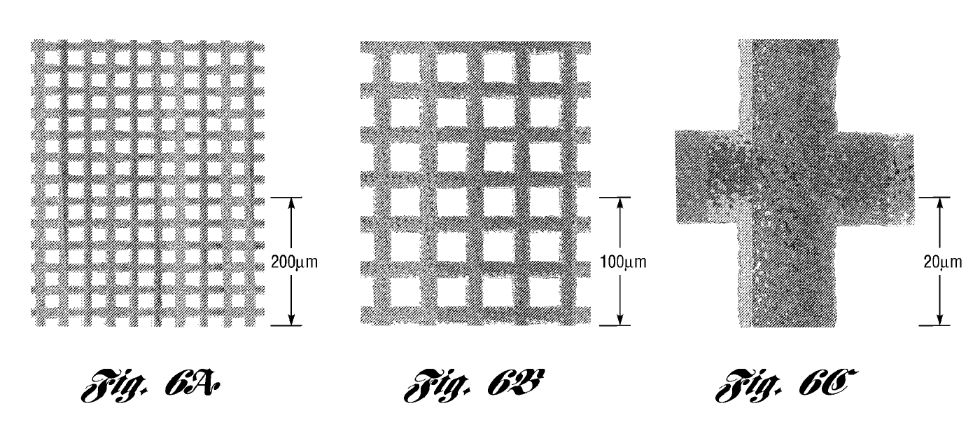

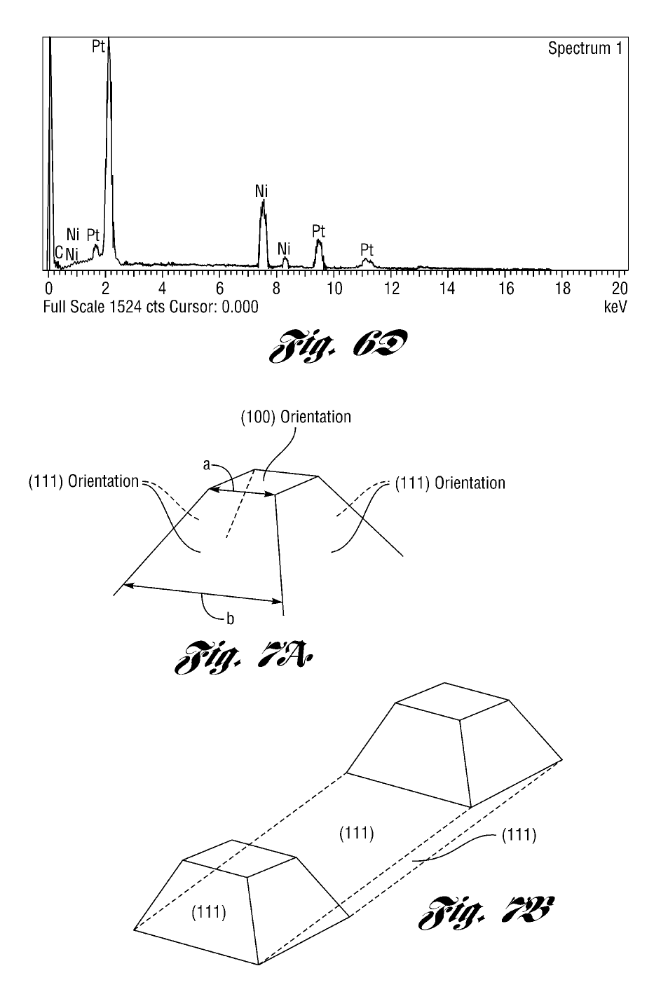

The mesh substrate having the interconnected network as illustratively shown in FIGS. 6A-6C can be mass produced using stamping/electrodepositon techniques for nanofabrication. Stamping techniques for micro and nano-fabrication applications have matured and are discussed in the literature extensively. Exemplary stamping methods may be had according to Mirkin et al. “Emerging methods for Micro- and nanofabrication”, MRS bulletin, July 2001; and Walker et al. “Growth of thin platinum films on Cu (100): CAICISS, XPS and LEED studies”, Surface Science 584 (2005) 153-160. Nanofabrication methods, such as soft lithography have also been used to transfer a mesh pattern of openings to a metallic thin film of gold with thickness of 100 nanometers (nm). Please see FIGS. 6A-6C with increasing magnification. As such, the mesh substrate can be used to support the continuum film of the metallic catalyst to form the fuel cell catalyst layers. Exemplary nanofabrication method can be had according to “Patterned transfer of metallic thin film nanostructures by water-soluble polymer templates” authored by C. D. Schaper, Nano Lett., Vol. 3, No. 9, 2003.

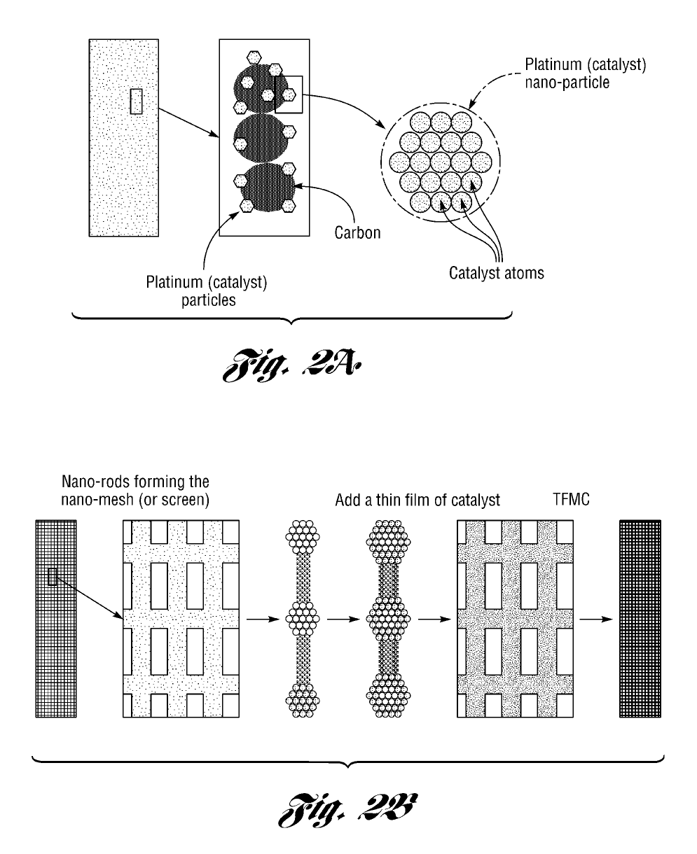

A conceptual schematic for TFMC is shown in FIGS. 2 and 3. FIGS. 2B and 2A depict conceptual schematic for TFMC along with conventional nano-particles with carbon support for comparison, respectively.

FIG. 2A depicts conventional carbon supported platinum commonly used in PEMFC catalyst layer wherein most if not all of the catalyst nano-particles are distinguishable and do not form a continuum. FIG. 2B shows that, in TFMC, no individual catalyst particle exits. Instead the nano particles with carbon support are replaced with a (metallic or non-metallic) nano-sized mesh with a thin film of catalyst deposited on it.

FIG. 3 depicts PEMFC equipped with a Thin film mesh catalyst (TFMC) supported on a mesh substrate. Schematic shows operation of the cathode. Similar concept may be constructed for the anode. The mesh could be entirely made of catalyst if so desired. Note that the catalyst atoms in this design form a continuum film in overlaying contact with the mesh grid surfaces. The catalyst metal in the form of a thin continuum film has a much lower surface energy compared to conventional catalyst-nano-particles on carbon support and therefore more stable. Moreover, the catalyst continuum film according to one or more embodiments of the present invention may be grown as nano-structures mostly having single crystals so as to generate potential for gaining higher activity. FIG. 3A depicts the TFMC in a planar view along the line 3A-3 A.

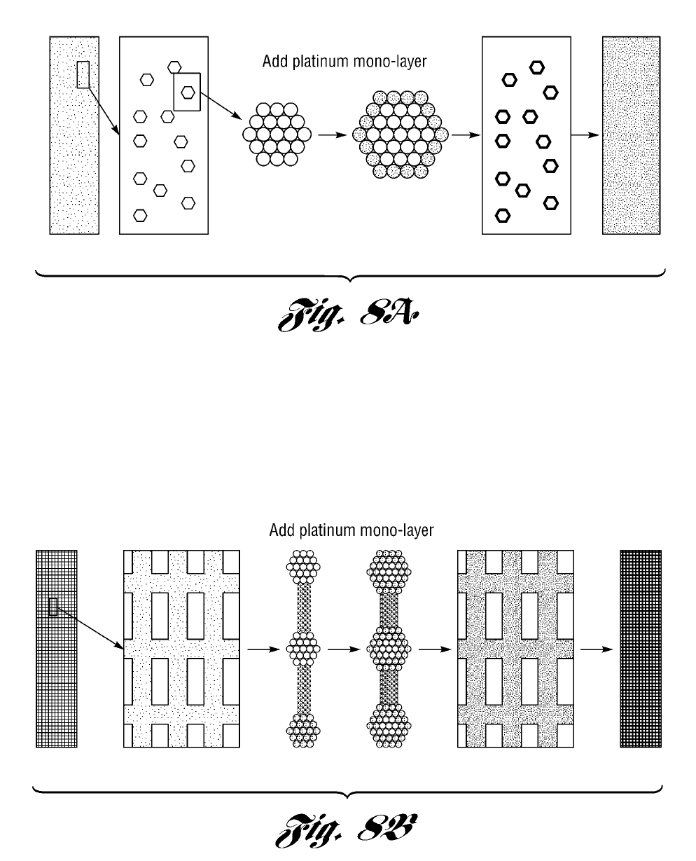

According to one or more embodiments of the present invention, the metallic catalyst as contained within the continuum film is configured as single crystalline, polycrystalline, or combinations thereof. In the event that the single crystals are used to form the TFMC, the single crystals of preference in case of platinum catalyst are characterized as having (111) facets not necessarily in parallel alignment with the plane of the TFMC. In certain particular embodiments, the single crystals are each provided with 4 to 20 atomic layers, and particularly 8 to 12 atomic layers, such that precious catalyst metals can be effectively used. Alternatively, in the event that the polycrystalline crystals are used, the preferred polycrystalline for platinum or alloys is characterized as having (111) facets and (100) tops, as illustratively seen in FIG. 7A. This nano-structure can be grown along diagonal to expose maximum numbers of highly active (111) facets as shown in FIG. 7B.

According to one or more embodiments of the present invention, the mesh substrate is configured, possibly through modifying the number of the grids and or the size of the openings as defined by the grids, to support a loading of the catalyst metals in an amount of less than 0.1 milligrams per square centimeter, 0.01 to 0.09 milligrams per centimeter, 0.02 to 0.08 milligrams per square centimeter, or particularly 0.03 to 0.07 milligrams per square centimeter. These catalyst loading amounts depart from the conventional wisdom which often requires anywhere from 0.1 to 0.5 milligrams per square centimeter of precious metals such as platinum, and therefore offer substantial economic benefits and relieve to some extent to the imminent shortage of platinum as an overly required natural resource.

According to one or more embodiments of the present invention, the mesh substrate is provided with a porosity of from 25 to 75 percent, or more particularly from 35 to 65 percent.

As used herein, the term “porosity” refers to a fraction of the void spaces defined by the one or more openings in the catalyst layer. Within this regard, the porosity is a function of size, shape and numbers of openings and grids, and thickness of the continuum film. As a combination parameter, the porosity may be adjusted to accommodate a particular catalyst loading requirement suitable for certain applications. In addition, when the continuum film is relatively thick, an effective catalytic active area of the catalyst layer may be further increased by growing or depositing catalyst metals on the side walls (e.g., perpendicular to the facile plane of the catalyst layer) of the openings without having to necessarily increase or decrease the porosity of the catalyst layer.

According to at least another aspect of the present invention, the aforementioned thin film mesh catalyst may be incorporated with a proton exchange membrane to form an electrode assembly or to form a membrane electrode assembly (MEA). The MEA according to the present invention may be used as a central element of a proton exchange membrane fuel cell, such as a hydrogen fuel cell.

Fuel cells are electrochemical cells which produce usable electricity by the catalyzed combination of a fuel such as hydrogen and an oxidant such as oxygen. A typical MEA includes a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. In hydrogen PEM fuel cell, protons are formed at the anode via hydrogen oxidation and transported across the PEM to the cathode to react with oxygen, causing electrical current to flow in an external circuit connecting the electrodes, while generating product water in the cathode.

Each electrode layer includes electro-catalysts, typically including platinum metal. The PEM forms a durable, non-porous, electrically non-conductive mechanical barrier between the reactant gases, yet it is ionically conductive by hydrogen protons. Gas diffusion layers (GDLs) facilitate gas transport to and from the anode and cathode electrode materials and conduct electrical current.

The GDL is both porous and electrically conductive, and is typically composed of carbon fibers. The GDL may also be called a fluid transport layer (FTL) or a diffuser/current collector (DCC). In some embodiments, the anode and cathode electrode layers are applied to form catalyst-coated gas diffusion electrodes (GDEs).

The PEM according to the present invention may comprise any suitable polymer electrolyte or its derivatives. The polymer electrolytes useful in the present invention illustratively include copolymers of tetrafluoroethylene and one or more fluorinated, acid-functional comonomers. Typical polymer electrolytes include Nafion® (DuPont Chemicals, Wilmington Del.) and Flemion™ (Asahi Glass Co. Ltd., Tokyo, Japan). While Nafion® is a common PEM, the usefulness of this invention is not limited by a particular choice of Nafion or any other solid electrolyte. In fact, liquid electrolytes and solid electrolytes are both amenable to one or more embodiments of the present invention.

According to one or more embodiments of the present invention, vacuum deposition techniques, preferably electron beam physical vapor deposition (EB-PVD) or RF sputtering, may be used to deposit the metallic catalyst onto a support. Any suitable stamping techniques for micro or nano-fabrication applications can be used to manufacture the mesh substrate support according to one or more embodiments of the present invention. For instance, nanofabrication methods, such as soft lithography can be used to illustratively transfer a pattern of openings to a metallic thin film. FIGS. 6A-6C depict a pattern of openings defined by grids in nickel of approximately 100 nanometers in depth. This substrate may easily be adapted to manufacture TFMC based catalyst layers. In fact, the TFMC as illustratively shown in FIG. 4 is made of the mesh substrate shown in FIGS. 6A-6C.

Vacuum deposition techniques are routinely employed in a variety of applications ranging from metalized layers in the fabrication of semiconductors to barrier coatings for food packaging, hard coatings for cutting tools, and optical thin films. Some of the typical methods employed include chemical vapor deposition, physical vapor or thermal deposition, ion sputtering, and ion beam assisted deposition (IBAD). Because the materials are deposited in a vacuum (typically less than 13.3 mPa, or 1×10⁻⁴ torr), contamination of the films can be minimized while maintaining good control over film thickness and uniformity. Such techniques, in many cases, lend themselves to deposition of materials over large areas via a reel-to-reel or web coating processes.

It is an advantage, according to one or more embodiments of the present invention, that catalyst dissolution common to conventional systems can be effectively reduced through the implementation of continuum film of metallic catalysts supported on a mesh substrate, according to one or more embodiments of the present invention. Degradation due to particle dissolution may be removed since metallic catalyst presented as a continuum film on a mesh substrate is intrinsically more stable than platinum nano-particles due to the lower surface energy associated with films.

It is a further advantage, and according to one or more embodiments of the present invention, that catalyst agglomeration inherent in conventional carbon-supported catalyst nano-particles can be effectively reduced. Degradation due to particle agglomeration may be removed. The catalyst layer based on metallic thin film does not contain particles and the surface properties of thin films more resemble that of the bulk catalyst than nano-particles.

It is a further advantage, and according to one or more embodiments of the present invention, that carbon support for the catalyst layers can be reduced or eliminated. As a result, issues such as carbon support corrosion and large Ohmic losses for electron transfer through carbon support may be avoided since essentially no carbon is necessarily used to support the catalyst in TFMC concept. Furthermore, peroxide formation that degrades membranes is significantly reduced.

It is a further advantage, and according to one or more embodiments of the present invention, that catalyst loading can be substantially reduced through the implementation of the catalysts configured according to one or more embodiments of the present invention.

It is a further advantage, that catalysts according to one or more embodiments of the present invention can potentiate multi-fold increase in catalytic activity over the conventional catalyst nano-particles on carbon support. With catalysts configured as conventional nano-particles, only surface atomic layers of the nano-particles are accessible to fuel cell reactants and remain active for electrochemical reaction, while the rest of the catalyst metal at the center of the nano-particle remains essentially inactive. By utilizing TFMC, one may control and optimize the number of atomic layers deposited on the substrate, and therefore save significantly on precious metal loading, as detailed herein. The thin film in TFMC may be grown to expose single crystalline (111) features of platinum and thereby increase catalytic activity 9 times. This feature is not possible with conventional platinum-carbon particles.

It has been found, according to one or more embodiments of the present invention, TFMC may be used to implement the electro-catalyst alloy Pt₃Ni with “Pt-Skin” and “Core-Shell” catalysts in fuel cells. This alloy is potentially 90 times more active than Pt/C with almost two orders of magnitude improvement. Conventional systems in utilizing Pt₃Ni catalyst in fuel cells are presented with challenges of creating nano-catalysts with electronic and morphological properties similar to Pt₃Ni (111). Given that thin films may be grown into well defined crystalline surfaces according to one or more embodiments of the present invention, the incorporation of Pt₃Ni (111) to fuel cells can be realized and practiced with greater certainty.

It is advantageous, according to one or more embodiments of the present invention, the lowest possible surface energy for the fuel cell catalyst continuum film should be sought to obtain better stability against various degradation modes. The equilibrium shape of a catalyst crystal is determined by minimizing the surface energy while keeping the volume constant. According to Wulff's theorem (GC Benson, D. Patterson; “Note on an analytical proof of Wulff's theorem in three dimensions”; J. Chem. Phys. Vol 23, 670, 1955), the equilibrium shape is obtained when there exists a point whose distances from various faces of the crystal are proportional to their surface free energies per unit area. For certain particular catalysts such as Pt₃Ni, it may be desired to have (111) surfaces exposed.

It is a further advantage that TFMC is easier to recycle. Catalyst layers based on TFMC may be recycled by simply removing the mesh/substrate and leaching/smelting the TFMC from its surface.

Having generally described this invention, a further understanding can be obtained by reference to certain specific examples which are provided herein for purposes of illustration only and are not intended to be limiting unless otherwise specified.

### EXAMPLES

### Example 1

Several mesh substrates made of copper and nickel and deposited platinum on both sides using sputtering are acquired. The thickness of the platinum deposit is controlled to provide a measurement of the catalyst loading. The Nickel mesh is provided with 750 wires per inch in the X and Y directions. The wire diameter is 0.00034″ or 0.008636 millimeters with square sizes of 0.00099″ or 0.025146 millimeters with 55 percent of porosity presented with the mesh openings. A platinum layer with thickness of 15 nanometers is deposited on this mesh using sputtering techniques. This translates into a loading of about 0.032 milligrams per square centimeters (mg/cm²), which is much lower than the loading on commercially available MEAs. The TFMC thus prepared is shown in FIG. 4 along with the GDL that is used in this example. FIG. 4 illustratively a thin film mesh catalyst (TFMC) with a nickel base and 15 nanometers platinum deposition along with the GDL.

FIGS. 6A, 6B, and 6C depict, with increasing magnification, micro-graphs of the same mesh shown in FIG. 4. FIG. 6D illustrates spectrum from SEM-assisted elemental analysis showing presence of nickel and platinum.

The TFMC is cut to an area of 5 square centimeters and hot pressed against a GDL, (LT 120-W woven, from E-Tek) with a Nafion 117 membrane. This setup is used on the cathode side of a fuel cell fixture from Fuel Cell Technologies (FCT). On the anode side a conventional electrode, LT-120E-W from E-Tek with 5 grams platinum per square meters is used.

The cell is operated at 70 degrees Celsius with 1000/300 sccm of air/hydrogen on the cathode/anode, respectively, and at 0.5 Volts for 24 hours to allow proper conditioning. The inlet humidity is maintained at 100 percent and outlets are exhausted to ambient.

The Open Circuit Voltage (OCV) measurements indicate a voltage of 0.95 Volts that proves oxygen reduction reaction (ORR) activity. The maximum current derived from this setup is at 0.1 Volts for about 250 milliamp (mA). In order to achieve higher currents, the platinum loading and structure on TFMC needs to be adjusted to expose maximum numbers of highly active (111) facets and crystalline structure. In addition, the wire density or surface area also needs to be increased.

### Example 2

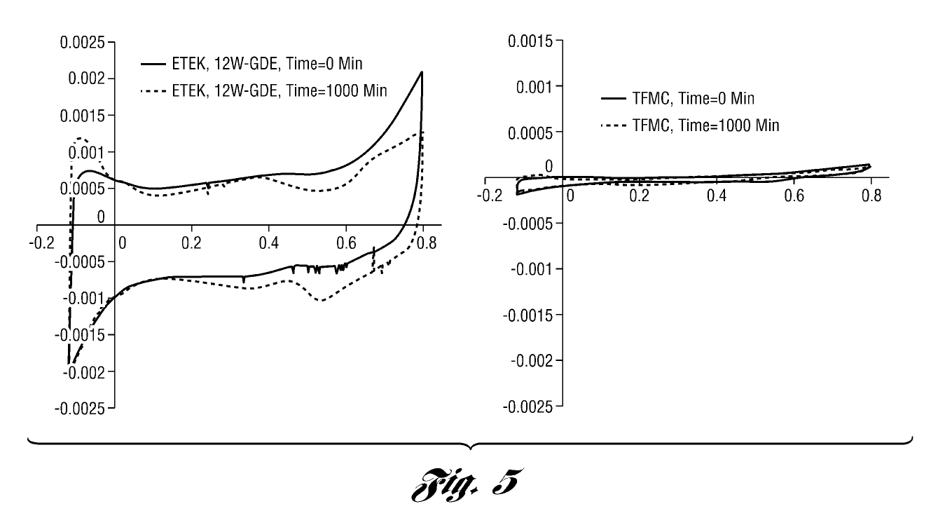

Potential cycling followed by cyclic voltammetry (CV) is performed to examine TFMC durability. The experiment is done in a tri-cell setup with 1 Molar Sulfuric Acid. The CV is adjusted to sweep −0.12 V to 0.8 V versus Silver/Silver Chloride Reference Electrode. The potential cycling is done as a square wave with a potential oscillating from 0.95 to 0.15 V. The values from CV procedures before and after 1800 cycles are plotted in FIG. 5. FIG. 5 depicts ADT for the conventional GDE (a) and TFMC (b).

As demonstrated in FIG. 5, the CV for the conventional GDE varies significantly after 1000 minutes of cycling, while the CV for TFMC shows little change either before or after the cycling. The electric currents are relatively low in the TFMC, which is a consequence of very small exposed area as compared to a conventional GDE.

Since it may be expensive or impractical to have a single crystal of (111) on the entire surface of the mesh substrate support, an alternative polycrystalline thin film based on a (111) faceted pyramid with a (100) top, as seen in FIG. 7, is used herein according to one or more embodiments of the present invention. FIG. 7 depicts TFMC based on Pyramid shaped with (111) and (100) surfaces. The dimensions “a” and “b” can be determined to minimize the surface energy. As seen in FIG. 7, more than 90 percent of the surface of the grain can expose the (111) surface of the catalyst.

According to one or more embodiments of the present invention, and as illustrated in FIG. 7, the polycrystalline metallic catalyst continuum film is provided with a minimum energy when the dimensions are such that a value for “a” is of about 2 nanometers and a value for “b” is of about 6 nanometers. This makes the height of the pyramid of about 4 nanometers. The lattice constant for Platinum is about 3.96 Angstrom, or 0.396 nanometers. Therefore the number of atomic layers in the thin film will be 4/0.396 or about 10 atomic layers.

While the best mode for carrying out the invention has been described in detail, those familiar with the art to which this invention relates will recognize various alternative designs and embodiments for practicing the invention as defined by the following claims.

What is claimed:

1. A fuel cell catalyst layer comprising:
an interconnected network of first spaced apart strands extending longitudinally in a first direction and second spaced apart strands extending longitudinally in a second direction, the interconnected network defining a number of openings bonded by an adjacent pair of the first spaced apart strands and an adjacent pair of the second space apart strands, and the number of openings forming a passage way; and
a metallic catalyst in overlaying contact with at least a portion of the first and second spaced apart strands in the interconnected network.

2. The fuel cell catalyst layer of claim 1, wherein the metallic catalyst includes catalyst atoms aligned along at least one of the first and second spaced apart strands.

3. The fuel cell catalyst layer of claim 2, wherein the catalyst atoms are in electronic communication with each other.

4. The fuel cell catalyst layer of claim 1, wherein the first and second spaced apart strands are formed of metallic materials, natural polymer materials, synthetic polymer materials, ceramic materials, textile materials, or combinations thereof.

5. The fuel cell catalyst layer of claim 1, wherein the passage way is configured to pass fuel cell reactants including hydrogen molecules, oxygen molecules, water molecules, and combinations thereof.

6. The fuel cell catalyst layer of claim 1, wherein the metallic catalyst includes single crystalline structures, polycrystalline structures, core-shell structures, or combinations thereof.

7. The fuel cell catalyst layer of claim 6, wherein the metallic catalyst includes platinum and is provided with at least one platinum (111) facet.

8. The fuel cell catalyst layer of claim 1, wherein the interconnected network supports a loading of the metallic catalyst in a range of 0.001 to 0.5 milligrams per square centimeter of total planar surface area of the interconnected network.

9. The fuel cell catalyst layer of claim 1, wherein the interconnected network is provided with a porosity of from 5 to 95 percent of total planar surface area of the interconnected network.

10. The fuel cell catalyst layer of claim 6, wherein the metallic catalyst is provided with atomic layers forming a single crystalline structure.

11. The fuel cell catalyst layer of claim 1, wherein the metallic catalyst includes catalyst metals selected from the group consisting of platinum, gold, silver, palladium, rhodium, iridium, ruthenium, and combinations thereof.

12. The fuel cell catalyst layer of claim 1, wherein the metallic catalyst includes core-shell nano-structures.

13. A fuel cell catalyst layer comprising:
an interconnected network of first spaced apart strands extending longitudinally in a first direction and second spaced apart strands extending longitudinally in a second direction, the interconnected network defining a number of openings bonded by an adjacent pair of the first spaced apart strands and an adjacent pair of the second space apart strands, and the number of openings forming a passage way for passing fuel cell reactants including hydrogen molecules, oxygen molecules, water molecules, and combinations thereof; and
a metallic catalyst in overlaying contact with at least a portion of the first and second spaced apart strands and including catalyst atoms aligned along at least one of the first and second spaced apart strands in the interconnected network.

14. The fuel cell catalyst layer of claim 13, wherein the catalyst atoms are in electronic communication with each other.

15. The fuel cell of claim 13, wherein the interconnected network is provided with a porosity of from 5 to 95 percent of total surface area of the interconnected network.

16. A fuel cell electrode assembly comprising:
a proton exchange membrane; and
a catalyst layer disposed next to the proton exchange membrane, the catalyst layer including:
an interconnected network of first spaced apart strands extending longitudinally in a first direction and second spaced apart strands extending longitudinally in a second direction, the interconnected network defining a number of openings bonded by an adjacent pair of the first spaced apart strands and an adjacent pair of the second space apart strands, and the number of openings forming a passage way for passing fuel cell reactants including hydrogen molecules, oxygen molecules, water molecules, and combinations thereof; and
a metallic catalyst in overlaying contact with at least a portion of the first and second spaced apart strands and including catalyst atoms aligned along at least one of the first and second spaced apart strands in the interconnected network.

17. The fuel cell electrode assembly of claim 16, wherein the catalyst atoms are in electronic communication to each other.

18. The fuel cell catalyst layer of claim 16, wherein the interconnected network is configured to support a loading of the metallic catalyst in a range of 0.01 to 0.09 milligrams per square centimeter of total planar surface area of the interconnected network.

19. The fuel cell electrode assembly of claim 16, wherein the interconnected network is provided with a porosity of from 25 to 75 percent of total planar surface area of the interconnected network.

20. The fuel cell electrode assembly of claim 16, wherein at least a portion of the number of openings are filled with an ionomer.
